(19) United States
(12) Patent Application Publication
(10) Pub. No.: US 2005/0157722 A1
(43) Pub. Date: Jul. 21, 2005

(54) Access user management system and access user management apparatus

(76) Inventors: Tetsuro Yoshimoto, Kokubunji (JP); Masatoshi Takihiro, Yokohama (JP); Takashi Yokoyama, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/894,061

(22) Filed: Jul. 20, 2004

(30) Foreign Application Priority Data
Jan. 19, 2004 (JP) 2004-010011

(51) Int. Cl. H04L 12/56; H04L 12/28

(52) U.S. Cl. 370/392

(57) ABSTRACT

A server having a function of authenticating a user, a function of confirming a connection state of the user by periodically transmitting a re-authentication request packet or a connection confirmation packet to the user and receiving a response, and a function of setting policy routing of an access server is used. A terminal communicates with the server instead of a Web browser to perform authentication at the initial start-up stage, and activates a client for responding to the re-authentication request packet or connection confirmation packet to thereby retain the connection state. Alternatively, a server having a function of authenticating a user is installed at the position of the authentication Web server. The terminal communicates with the server instead of the Web browser to perform authentication at the initial start-up stage, and a client for periodically performing authentication is activated thereafter to thereby retain the connection state.

### INCORPORATION BY REFERENCE

The present application claims priority from Japanese application JP 2004-010011 filed on Jan. 19, 2004, the content of which is hereby incorporated by reference into this application.

### BACKGROUND OF THE INVENTION

The present invention relates to access user management for broadband Internet connections.

User authentication is very important technologies in order to ensure securities of network communications. PPPoE (Point-to-Point Protocol over Ethernet) (“Ethernet” is a registered trademark) is currently used widely for access user authentication and access user state management in broadband Internet connections. PPPoE has been developed from PPP used for dial-up connections and made usable on the Ethernet, can authenticate users at Layer 2 by using an authentication protocol, and can monitor a user connection state by periodically requesting user re-authentication or by using an LCP Echo packet. The PPPoE technologies are disclosed in RFC2516: A Method for Transmitting PPP Over Ethernet (PPPoE).

Another authentication uses the communication standards called IEEE802.1x. This method authenticates in the unit of port at Layer 2 and is presently used often for local wireless connection authentication. User authentication is possible at Layer 2 by using the authentication protocol, and a user connection state can be monitored by periodically requesting for user re-authentication. An example of the user terminal authentication method using the communication standards of IEEE802.1x is disclosed in Japanese Patent Laid-open Publication No. JP-A-2003-224577. The communication standards are shown in IEEE802.1X-2001: IEEE Standards for Local and Metropolitan Area Networks: Port-Based Network Access Control, Section 6, pp. 7-13.

The above-described two authentication methods can perform user management at Layer 2. Authentication of access users can be performed by using a combination of a policy routing function which is generally built in recent routers and authentication at an application layer level by the World-Wide-Web (Web). According to this authentication method, an access server (router) directly connecting an access user at Layer 3 is set so that a user can access only a particular Web sever at the initial connection stage by using the policy routing function. The Web browser is subjected to authentication after a user connection, and the Web server again sets the access server so that only the IP address of the authenticated user is ordinarily routed.

FIG. 10 is a diagram showing the hardware structure of a general access server. A CPU 31 is used for managing users, and when necessary, executes a complicated process such as routing by software. A memory 32 is used by CPU 31 and stores software and data necessary for the access server. The memory 32 has at least a session or connection information management unit 321 for storing terminal connection information, an external server cooperation unit 322 for receiving a connection information update request from an external and outputting a state change instruction to the connection information management unit 321 and a packet forwarding setting unit 323, and a packet forwarding unit setting unit 323 for updating information of a packet forwarding engine 33 in accordance with an instruction from the connection information management unit 321 and external server cooperation unit 322. Although packet transfer can be executed by CPU 31 using software, in many cases an independent packet forwarding engine is provided which can transfer a packet at higher speed than using CPU 31. The packet forwarding engine may be a processor constituted of hardware logic alone, or may be a special MPU dedicated to packet transfer called a network processor. A normal packet forwarding engine 331 can perform general packet transfer at high speed. A policy routing unit 332 has a function of overriding the transfer result by the packet forwarding engine 331 for a packet having a particular pattern and changing a packet transfer destination in accordance with a policy. The packet forwarding engine 331 and policy routing unit 332 may be realized by hardware or software, depending upon the structure of the packet forwarding engine 33. A network interface (NIF) 34 is used for actual physical connection to a network. These modules described above are interconnected by a bus 35 which may be replaced by a switch.

### SUMMARY OF THE INVENTION

With reference to FIGS. 2 and 3, description will be made on a method of combining policy routing and Web authentication. FIG. 2 is a schematic system diagram. A terminal 5 is connected to the Internet 7 via an access server 3. The access server 3 is connected to a DHCP server 4 and a Web server 1. The Web server 1 is connected to an authentication server 2. The structure of software running on the terminal 5 is shown under the terminal 5. An OS 500 runs on the terminal 5, and a Web browser 501 and other network applications 502 run on OS 500.

FIG. 3 is a diagram showing the sequence of an authentication method combining policy routing and Web authentication. As the terminal 5 is activated, OS running on the terminal 5 tries to acquire an IP address from the DHCP server (S101). The access server 3 received a DHCP request transfers the request to the DHCP server 4 by using a DHCP relay (S102). The DHCP server 4 assigns an IP address to the terminal 5, and replies the result to the access server 3 (S103). The access server 3 transfers the IP address to the terminal 5 (S104), and the terminal 5 enters the state capable of IP communications.

At this point, policy routing is set by the access server 3 for the IP address assigned to the terminal 5 so that the terminal 5 cannot access freely the Internet 7. An Internet access S105 from the application 504 and an Internet access S106 from the Web browser 501 fail. A cross symbol shown in FIG. 3 means that both the Steps S105 and S106 cannot be realized. At this point the terminal 5 can access only the Web server 1. The terminal 5 accesses the Web server 1 to request for authentication by inputting the user name and password (S107). The Web server 1 received the authentication request transfers the authentication request to the authentication server 2 (S108). The Web server 1 received acknowledgement from the authentication server 2 (S109) performs settings in such a manner that the access server 3 removes the setting of policy routing for the IP address of the terminal 5 (S110). The terminal 5 can therefore access the Internet, an Internet access S111 from the Web browser 501 and an Internet access S112 from another application can succeed.

In the description with reference to FIGS. 2 and 3, the access server 3, Web server 1, authentication server 2 and DHCP server 4 are shown as discreet for the purposes of simplicity. However, these servers may be combined into smaller number of units as desired if they are equivalent in functions. Although DHCP is used as an example of IP address assignment, an optional method may be used for IP address assignment. For example, RA (Router Advertisement) may be used if the IP protocol is IPv6. Although the Web browser explicitly accesses the Web server 1 at Steps S106 and S107, Steps S106 and S107 may be changed to a continuous sequence by using a redirect function of the Web server.

PPPoE has an inferior communication efficiency because of addition of a PPP header and a PPPoE header, and has a limitation that the multicast function inherent to Ethernet cannot be used. Further, since PPPoE is the communication protocol at Layer 2, it is necessary for an access sever directly connected an access user at Layer 3 level to have the PPPoE function, resulting in a high cost of the access sever.

IEEE802.1x is the communication standards at Layer 2 similar to PPPoE although it has no limitation of the communication efficiency and multicast function. It is therefore necessary to mount a function corresponding to IEEE802.1x on the access server, resulting in a high cost of the access server.

The user authentication method combining policy routing and web authentication has no means for monitoring a user connection state. An access to the Internet by a user means that a particular network resource (e.g., an IP address assigned to a user via DHCP, etc) is assigned to the user, as viewed from an ISP (Internet Service Provider). With the present Web authentication method, it cannot be known whether a user assigned a network resource is presently connected to the Internet. Since network resources such as IPv4 addresses are limitative, it is not practical to make resources being assigned to a disconnected user. To overcome this, the access server 1 monitors data packet passing, and if a time-out comes, it is considered that the user is disconnected. The user IP address is set again so that it can access only the Web server, and when the user operate again the Web browser, re-authentication is requested.

With reference FIG. 3, description will be made on the re-authentication request operation by the access server upon time-out. In FIG. 3, S113 indicates a time-out period. If there is no IP access from the terminal 5 during the period indicated at S113, at S114 the access server 3 sets again policy routing relative to the IP address of the terminal 5. Thereafter, an Internet access S115 from an application of the terminal 5 fails. The user accesses again the Web server 1 by using the Web browser to repeat for the authentication operation at S116 to S119 similar to S107 to S110. With this re-authentication by the user, the terminal 5 on the user side can perform an Internet access S120. This increases an unnecessary load on the user. If the user uses only an application other than the Web browser, it is necessary to activate again the Web browser only for authentication so that convenience of all-time connection which is usual in broadband is degraded considerable.

It is therefore an object of the present invention to provide a novel Web authentication method and a Web authentication apparatus capable of providing the authentication method, the method and apparatus being capable of solving two issues; an issue that a conventional Web authentication method cannot grasp a user connection state and an issue that a user is required to perform a complicated task of repeating a re-authentication procedure.

The problem associated with the authentication method combining policy routing and Web authentication resides in that a Web browser unable to operate autonomously is used as the framework of authentication on the terminal side.

The present invention is therefore characterized in that in place of a conventional authentication Web server, a server is provided which has a function of confirming a user connection state and a function of transmitting a request of changing the policy of policy routing or a release request of releasing the current policy, to an access server in accordance with the confirmed user connection state. A client function capable of communicating with the server is installed on the terminal side. When it is confirmed that the user is disconnected, the access server inhibits the user from freely accessing the Internet.

When the terminal starts an access to the Internet, initial authentication is performed by using the client function in place of a Web browser. The client function mounted on the terminal is required to respond in the background relative to a connection confirmation request from the server. It is therefore possible for the terminal to maintain a connection state, without repeating the re-authentication by the user.

The above-described server and client may be dedicated to user management, or they may be a server for already existing applications having similar functions, the server provided with an access server setting function. An example of an already existing application is typically Instant Messenger (IM), which is presence awareness software for opening a user terminal use state to particular or unspecific users on the network, or a mail server (MTA) and a mail client (MUA), or the like.

As the server, one server may be provided with an authentication function possessed by a conventional authentication server and a function of transmitting a request of changing a policy of policy routing. Alternatively, a combination of a presence awareness server and a conventional authentication server may be used.

The server may send a re-authentication request to the terminal, instead of the connection confirmation request. In this case, however, a client mounted on the terminal is required to have a function of responding to the re-authentication request from the server in the background. The terminal periodically connects the server via the mounted client function to execute the re-authentication operation.

According to the present invention, without using a special access server capable of dealing with PPPoE and IEEE802.1x, it is possible to properly manage a user connection state and properly distribute resources such as an IP address to users.

Other objects, features and advantages of the invention will become apparent from the following description of the embodiments of the invention taken in conjunction with the accompanying drawings.

### BRIEF DESCRIPTION OF THE DRAWINGS

FIG. 1 is a sequence diagram illustrating the first embodiment of the present invention.

FIG. 2 is a schematic diagram showing a system with a method combining policy routing and Web authentication.

FIG. 3 is a sequence diagram illustrating the method combining policy routing and Web authentication.

FIG. 4 is a schematic diagram showing the system of the first embodiment of the invention.

FIG. 5 is a functional block diagram of an IM server used by the first embodiment of the invention.

FIG. 6 is a schematic diagram showing a system of the second embodiment of the invention.

FIG. 7 is a sequence diagram illustrates the second embodiment of the invention.

FIG. 8 is a functional block diagram of a periodical authentication client used by the second embodiment of the invention.

FIG. 9 is a schematic diagram of a terminal on which an authentication client runs.

FIG. 10 is a block diagram of a router.

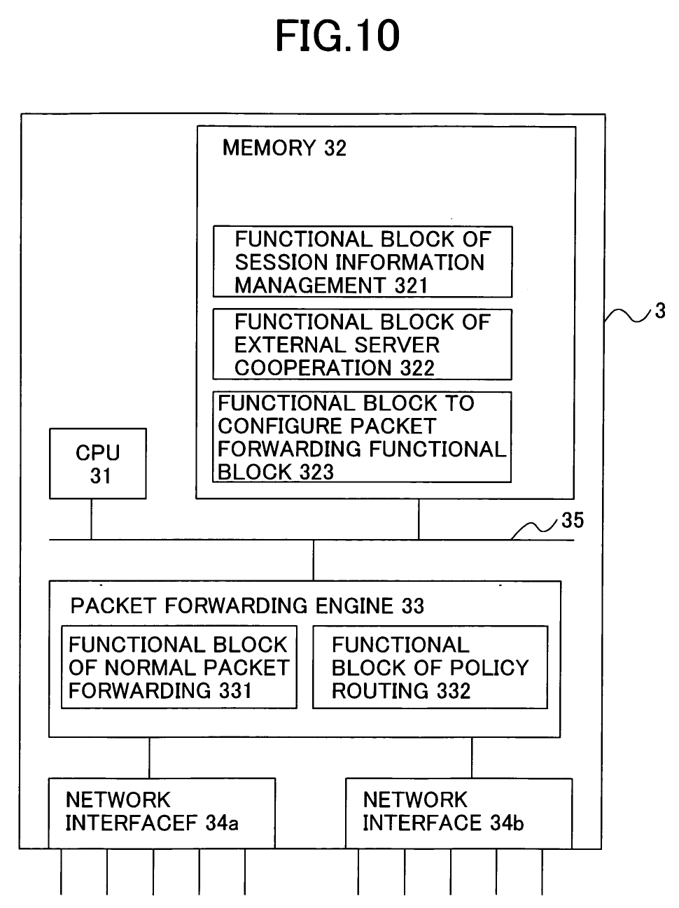

### DESCRIPTION OF THE INVENTION

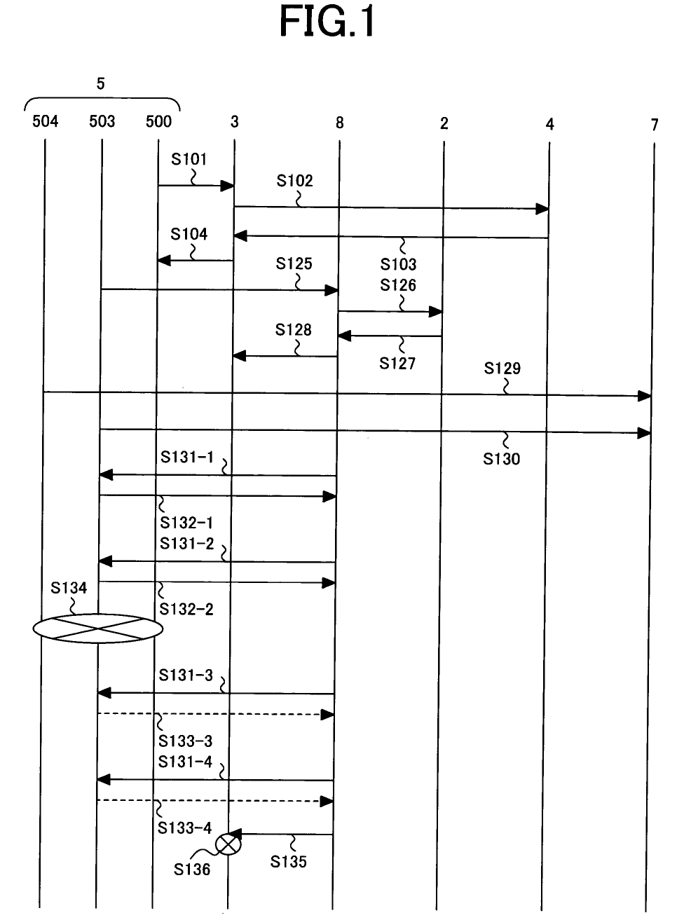

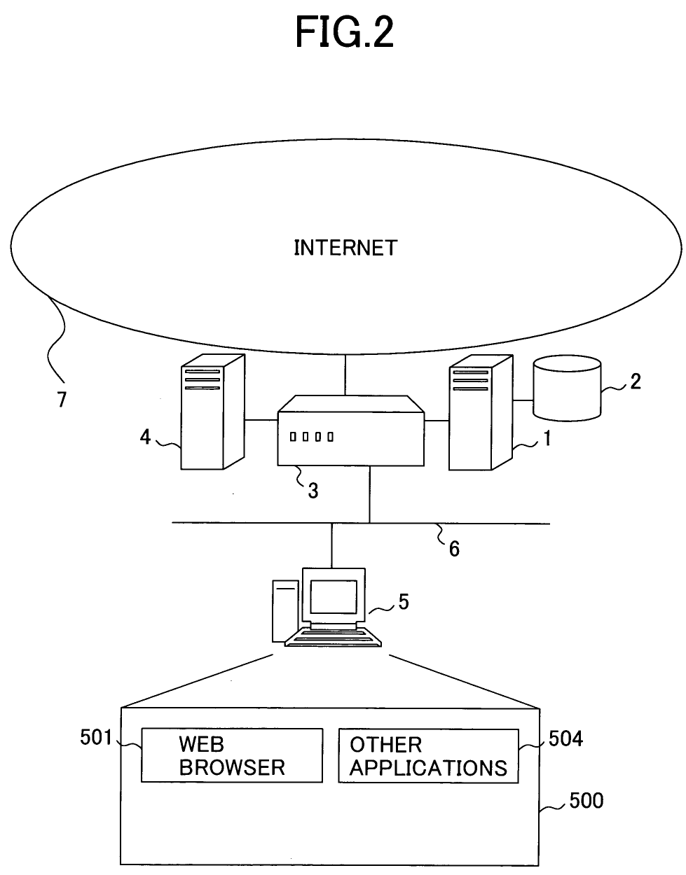

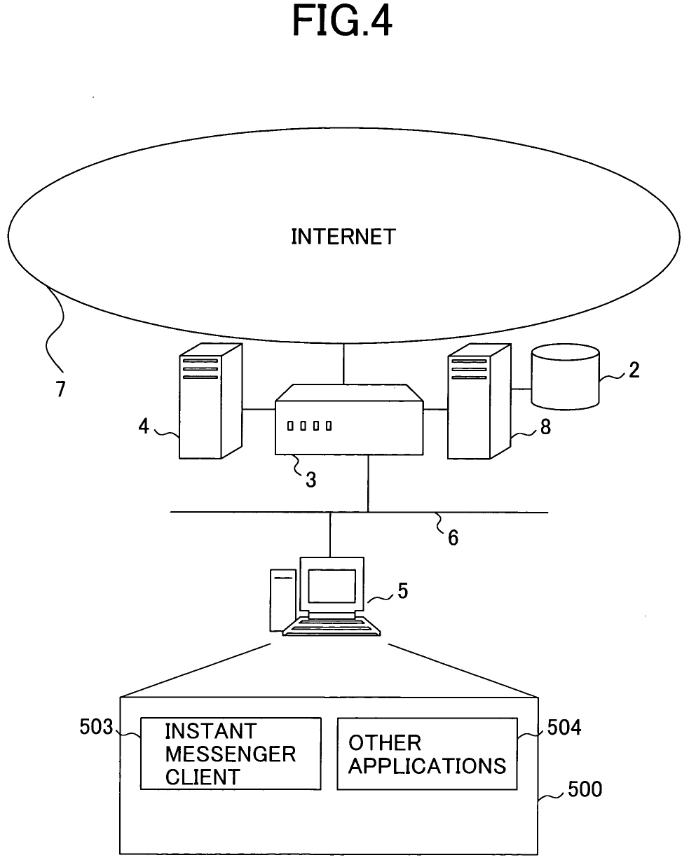

In the first embodiment, IM is used by way of example as an application which can acquire information of the network connection state of a user terminal. With reference to FIGS. 1, 4, 5 and 7, the detailed description will be given. FIG. 4 is a schematic diagram of a system of the present invention. As compared to FIG. 2, instead of the authentication Web server 1, an IM sever 8 is used which has an access sever setting function. Instead of the Web browser, an IM client 503 runs on a terminal 5, and other Internet applications 504 including a Web browser also run on the terminal 5.

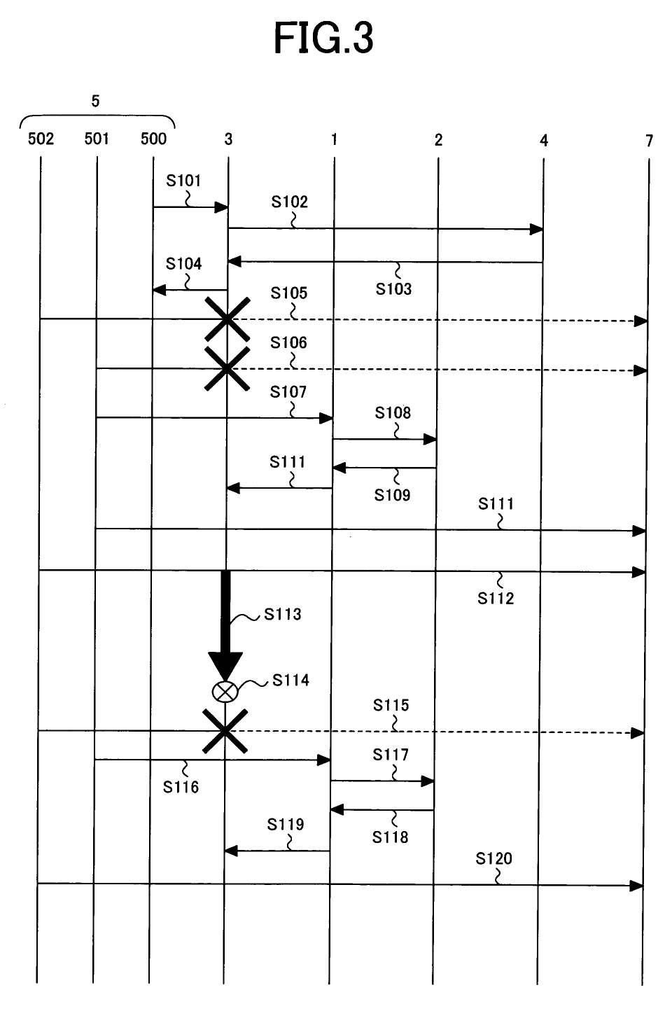

FIG. 1 is a sequence diagram illustrating the present invention. First, as the terminal is activated, an OS 500 acquires an IP address in the manner quite the same as that shown in FIG. 3 (S101 to S104). Next, the IM client 503 transmits an authentication request to the IM server 8, by using the user name and password (S125). The IM client is generally automatically activated when OS is activated, and the authentication request is automatically transmitted to the server when OS acquires the IP address. The IM server 8 received the authentication request transmits an authentication packet for authentication confirmation to the authentication server 2 (S126). If the user name and password are coincident with those registered in a database, the authentication server 2 transmits an acknowledge packet for authentication permission to the IM server 8 (S127). If the user name and password are not coincident, the authentication server 2 transmits a denial packet for authentication denial to the IM server 8.

Upon reception of the acknowledgement packet from the authentication server 2, the IM server 8 transmits a release request packet for releasing policy routing or a change request packet for requesting for a change in a routing control policy used by policy routing, to the access server 3 (S128). Therefore, the packet having the address of the terminal 5 as an address of a transmission source can be transmitted to any partner on the Internet 7 from the terminal 5 via the application 504, because the setting conditions of routing control set by the access server 3 are released or changed (S129). The IM client 503 can also access another IM server on the Internet 7 (S130).

After the authentication succeeds, the IM server 8 periodically transmits authentication confirmation or existence confirmation to the IM client 503 (S131). In response to this, the IM client returns an authentication request or an existence notice (S132). The IM server 8 can therefore confirm that the terminal 5 is in continuous communications. The user can access the Internet during the operation of the terminal, without performing a re-authentication operation.

Consider now that the terminal 5 stops at S134. Although the IM server continues to send authentication confirmation or existence confirmation, a response will not be returned because the terminal stops (S133). If this repeats a predetermined number of times, the IM server judges that the terminal is disconnected, makes the access server 3 perform the settings of policy routing relative to the IP address of the terminal 5 (S135). When the access server completes the settings at S136, the Internet resource assigned to the terminal 5 is released so that it can be used by another terminal.

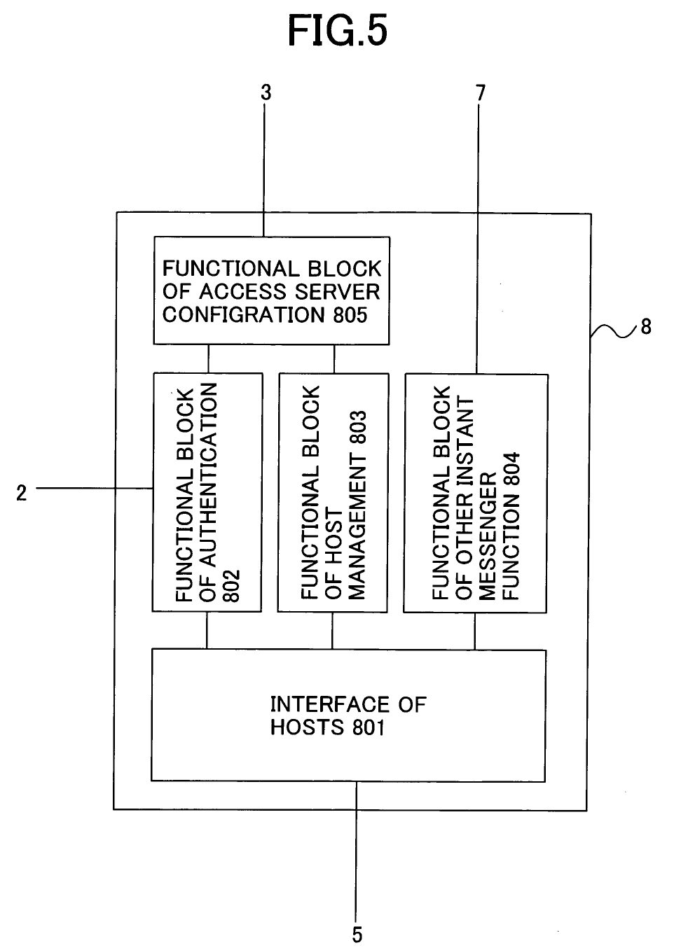

FIG. 5 is a functional block diagram of the IM server 8 of the present invention. A terminal interface unit 801 receives various data such as an authentication request from the terminal 5 and a message to another user, and distributes the data to each proper functional block. The terminal interface unit 801 supports the communication between the terminal 5 and each functional block in the IM server 8. An authentication unit 802 receives an authentication request from the terminal 5, and makes the authentication server 2 perform authentication confirmation to thereby judge whether the user is permitted to access. In this invention, the judgement result is also notified to an access server configuration (setting function) unit 805. A host (terminal) management unit 803 periodically transmits an authentication confirmation request or an existence confirmation request to the terminal 5, and manages the state of the terminal 5 by periodically receiving the response or periodically acknowledging a re-authentication request or an existence confirmation from the terminal 5. In this invention, the management state is also notified to the access server setting function unit 805. Another IM function unit 804 realizes the functions irrelevant to the present invention, such as message communications between the terminal 5 and another user. The access server setting function unit 805 is a functional block characteristic to the present invention, and performs the settings of policy routing and the like of the IP address of the terminal 5, relative to the access server.

Although the access server 3, IM server 8, authentication server 2 and DHCP server 4 are all discreet as described above, an optional combination of these servers may be used if it is functionally equivalent similar to conventional examples. A combination of the access server 3 and IM server 8 among others is effective for settings in the unit of port. A proxy server function provided in the access server as an alternative of communications between the IM server and terminal is effective for settings in the unit of port. Although DHCP is used as an example of IP address assignment, any IP address assignment method may be used.

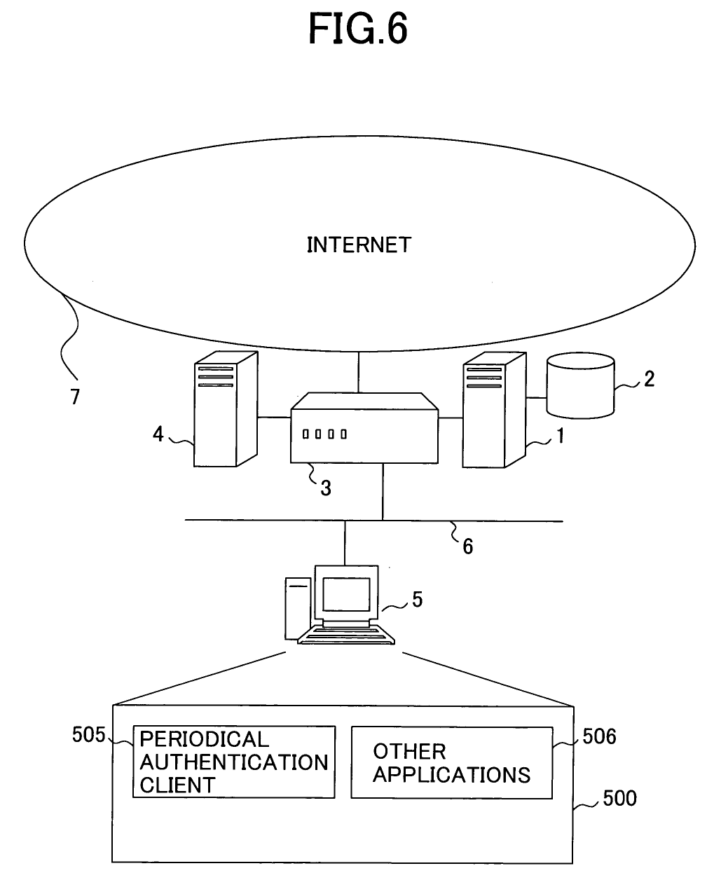

With reference to the accompanying drawings, an embodiment of the present invention will be described. This embodiment differs from the first embodiment in that the Web server 1 similar to the conventional example can be used as an application server connected to the authentication server. FIG. 6 is a schematic diagram showing a system of the present invention. As compared to FIG. 2, a periodical authentication client 505 operates on a terminal 5 instead of the web browser, and another Internet application 506 including the Web browser runs on the terminal.

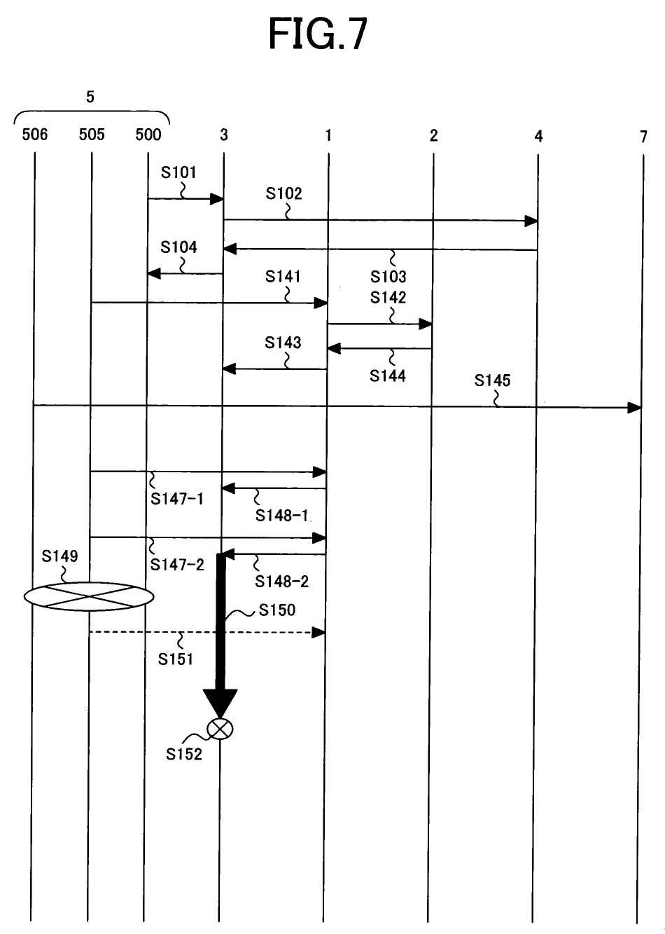

FIG. 7 is a sequence diagram illustrating the present invention. First, as the terminal is activated, an OS 500 acquires an IP address in quite the same manner as described with reference to FIG. 3 (S101 to S104). Next, the periodical authentication client 503 transmits an authentication request to an authentication Web server 1 by using the user name and password (S141). This operation is realized by performing the settings that the periodical authentication client is automatically activated when OS is activated and that the periodical authentication client automatically issues the authentication request to the server when OS acquires the IP address. The authentication Web server 1 received the authentication request inquires the authentication server 2 about the authentication confirmation (S142) to receive an acknowledgement S143 from the authentication server, and makes the access server to release the policy routing with a limited term (S144). In this manner, the application 506 on the terminal can access an arbitrary partner on the Internet 7 (S145). After the authentication success, the periodical authentication client periodically transmits authentication information to the authentication Web server 1 (S147). Upon reception of this, the authentication Web server 1 makes the access server to set an extension of the limited term of the policy routing releasing (S148). In this manner, a user can access the Internet during the operation of the terminal, without performing a re-authentication operation.

Consider now that the terminal 5 stops at S149. Since the terminal stops, authentication information cannot be transmitted (S151). If this state continues during a time-out period S150, the access server judges that the terminal is disconnected and performs the settings of the policy routing relative to the IP address of the terminal 5 (S152). When the settings at the access server are completed at S152, Internet resources are released for the terminal 5 so that they can be used by another terminal. In this example, although the time-out is set on the side of the access server 3, the time-out management may be performed by the authentication Web server 1, and at the time-out, the authentication Web server 1 makes the access server 3 to perform the settings of the policy routing.

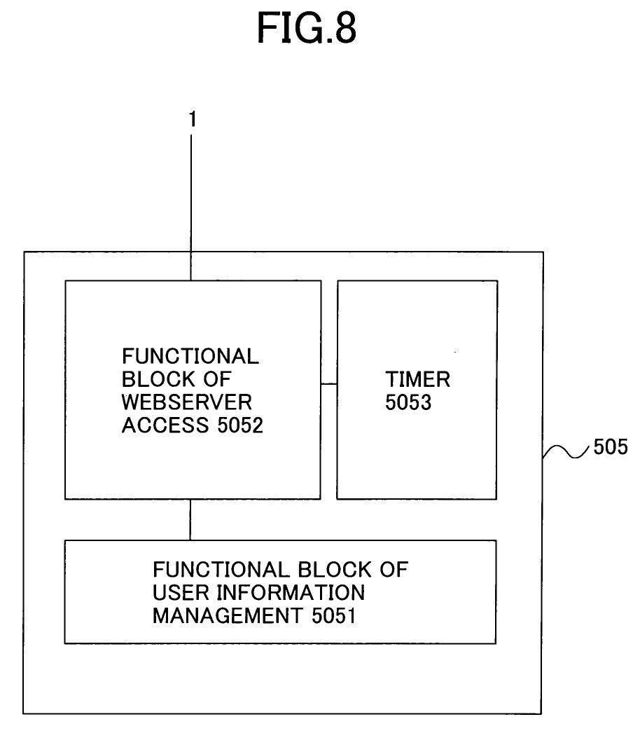

FIG. 8 is a functional block diagram of the periodical authentication client. A user information management unit 5051 manages information necessary for authentication such as user names and passwords. A Web server access unit 5052 converts the information managed by the user information management unit 5051 into the HTTP format and transmits it to the authentication server at the start-up time and when a notice is issued from a timer 5053. The timer 5053 notifies the access time to the authentication Web server via a Web server access unit 5052. Although the access server 3, authentication Web server 1, authentication server 2 and DHCP server 4 are all discrete as described above, an optional combination of these servers may be used if it is functionally equivalent similar to conventional examples. A combination of the access server 3 and authentication Web server 1 among others is effective for settings in the unit of port. A proxy server function provided in the access server as an alternative of communications between the authentication Web server and terminal is effective for settings in the unit of port. Although DHCP is used as an example of IP address assignment, any IP address assignment methods may be used.

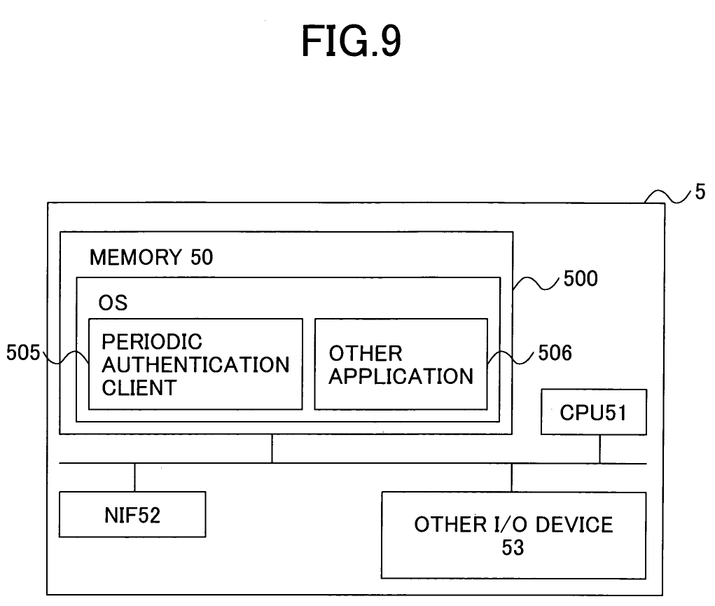

FIG. 9 is a schematic diagram showing the terminal on which the periodical authentication client runs. A memory 50 stores various programs (such as Web browser and mail software 506) to be used by the terminal. The periodical authentication client 505 is also stored separately. A CPU 51 executes software in the memory 50. An NIF 52 is a module for physical connection to the network. Other I/O devices 53 are a keyboard, a display and the like. By using these devices, a user of the terminal 5 utilizes software.

It should be further understood by those skilled in the art that although the foregoing description has been made on embodiments of the invention, the invention is not limited thereto and various changes and modifications may be made without departing from the spirit of the invention and the scope of the appended claims.

1. An access user management method to be used when a user terminal is connected to a network by using an access server for connecting said user terminal to the network in response to reception of an access request from said user terminal, a monitor server for monitoring a connection state of said user terminal to the network and an authentication server for authenticating said user terminal transmitted the access request to said access server, wherein:
said access server receives an access request from said user terminal;
if said access request is an access request from said user terminal not authenticated, a routing control condition of said access server is changed to make a packet transmitted from said user terminal be transferred to said authentication server;
if said access request is an access request from said user terminal already authenticated, the routing control condition of said access server is changed to make a packet transmitted from said user terminal be connected to the network;
said monitor server monitors an access state of said authenticated user terminal to the network; and
for the packet transmitted from the user terminal and judged by said monitoring server that said user terminal is not accessing the network, the routing control condition of said access server is set so that the packet is not transferred to said authentication server.

2. An access user management method according to claim 1, wherein said monitor server and said authentication server are a same server.

3. An access user management method according to claim 1, wherein:
said monitor server transmits an existence confirmation packet or a user authentication request packet to said user terminal; and
if there is no response from said user terminal during a predetermined period, it is judged that said network is not accessing the network.

4. An access user management method according to claim 3, wherein said user terminal issues a response to the existence confirmation packet or the user authentication request packet in a background.

5. An access user management apparatus comprising an access server for connecting a user terminal to a network in response to reception of an access request from the user terminal, a monitor server for monitoring a connection state of the user terminal to the network and an authentication server for authenticating the user terminal transmitted the access request to said access server, wherein:
said access server comprises:
means for transmitting/receiving a packet;
means for performing a predetermined routing control of the packet transmitted from the user terminal; and
means for changing a condition of the routing control in accordance with a received change request; and
said monitor server comprises:
means for transmitting/receiving a packet;
means for distinguishing whether a transmission source of a received packet is the user terminal authenticated or the user terminal not authenticated;
means for generating an existence confirmation packet or a re-authentication request packet to be transmitted to the user terminal already authenticated; and
means for generating a change request packet for changing a routing control condition to be transmitted to said access server; and
if there is no response to the existence confirmation request packet or the re-authentication request packet during a predetermined period, a change request of changing the routing control condition is transmitted to said access server; and
the routing control condition of said access server is set so that a packet transmitted from the user terminal not issuing the response during the predetermined period is transferred to said authentication server.

6. An access user management apparatus according to claim 5, wherein presence awareness software is mounted on said monitor server.

7. An access user management apparatus according to claim 6, wherein said presence awareness software is IM (Instant Messenger).

8. An access user management apparatus according to claim 5, wherein mail server software is mounted on said monitor server.

9. An application server to be connected to an access server for transferring a reception packet to the Internet, comprising:
means for transmitting/receiving a packet;
means for distinguishing whether a transmission source of a received packet is the user terminal authenticated or the user terminal not authenticated;
means for generating an existence confirmation packet or a re-authentication request packet to be transmitted to the user terminal authenticated;
a counter for counting a lapse time from when the existence confirmation packet or the re-authentication request packet is transmitted to the user terminal; and
means for generating a change request packet for changing a routing control condition to be transmitted to said access server;
wherein if there is no response to the existence confirmation packet or the re-authentication request packet during a predetermined period, the change request packet for changing the routing control condition is transmitted to said access server.

10. An application server according to claim 9, wherein mail server software is installed on the application server.

11. An application server according to claim 9, wherein an IM (Instant Messenger) function is installed on the application server.
